(19) United States
(12) Patent Application Publication
(10) Pub. No.: US 2023/0307743 A1
(43) Pub. Date: Sep. 28, 2023

(54) MULTI-LAYERED ENCLOSURE STRUCTURES FOR TRACTION BATTERY PACKS WITH CELL-TO-PACK BATTERY SYSTEMS

(71) Applicant: FORD GLOBAL TECHNOLOGIES, LLC, Dearborn, MI (US)

(72) Inventor: Jason C. MARCATH, Dearborn, MI (US)

(21) Appl. No.: 17/895,467

(22) Filed: Aug. 25, 2022

Related U.S. Application Data
(60) Provisional application No. 63/322,766, filed on Mar. 23, 2022.

(51) Int. Cl. H01M 10/6556; H01M 10/613; H01M 10/625; H01M 50/231

(52) U.S. Cl. CPC H01M 10/6556; H01M 10/613; H01M 10/625; H01M 50/231; H01M 2220/20

(57) ABSTRACT

Traction battery packs are disclosed that include cell-to-pack battery systems. A cell matrix of the cell-to-pack battery system may be positioned within an enclosure assembly of the traction battery pack. The enclosure assembly may include one or more multi-layered structures. Each multi-layered structure may include a first chamber and a second chamber. The first chamber provides an internal cooling circuit for thermally managing the cell matrix, and the second chamber provides an air gap for insulating the cell matrix from an exterior environment.

### CROSS-REFERENCE TO RELATED APPLICATIONS

This disclosure claims priority to U.S. Provisional Application No. 63/322,766, which was filed on Mar. 23, 2022 and is incorporated herein by reference.

### TECHNICAL FIELD

This disclosure relates generally to traction battery packs, and more particularly to traction battery packs that include a cell-to-pack battery system. The cell-to-pack battery system may be thermally managed by a multi-layered structure of an enclosure assembly of the traction battery pack.

### BACKGROUND

Electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A traction battery pack according to an exemplary aspect of the present disclosure includes, among other things, an enclosure assembly including an enclosure tray, and a cell-to-pack battery system housed within the enclosure assembly and including a cell matrix. A floor of the enclosure tray includes a first chamber that provides an internal cooling circuit for thermally managing the cell matrix, and a second chamber that provides an air gap for insulating the cell matrix from an exterior environment.

In a further non-limiting embodiment of the foregoing traction battery pack, the cell matrix includes a plurality of battery cells arranged to interface with an interior facing floor surface of an interior wall of the floor.

In a further non-limiting embodiment of either of the foregoing traction battery packs, the floor is connected to a plurality of side walls of the enclosure tray.

In a further non-limiting embodiment of any of the foregoing traction battery packs, the plurality of side walls are arranged to provide a cell-compressing opening for compressing the cell matrix.

In a further non-limiting embodiment of any of the foregoing traction battery packs, the internal cooling circuit extends between an interior wall and an internal wall of the floor.

In a further non-limiting embodiment of any of the foregoing traction battery packs, the internal cooling circuit includes a plurality of fluid channels that are at least partially separated from one another by a plurality of walls.

In a further non-limiting embodiment of any of the foregoing traction battery packs, the internal cooling circuit establishes a serpentine passage inside the first chamber.

In a further non-limiting embodiment of any of the foregoing traction battery packs, the first chamber is closer to the cell matrix than the second chamber.

In a further non-limiting embodiment of any of the foregoing traction battery packs, the second chamber extends between an internal wall and an exterior wall of the floor.

In a further non-limiting embodiment of any of the foregoing traction battery packs, the internal wall establishes a floor of the internal cooling circuit.

In a further non-limiting embodiment of any of the foregoing traction battery packs, the exterior wall includes an exterior surface that is exposed to the exterior environment.

In a further non-limiting embodiment of any of the foregoing traction battery packs, at least one standoff extends between the internal wall and the exterior wall of the floor.

In a further non-limiting embodiment of any of the foregoing traction battery packs, the air gap includes a static pocket of air inside the second chamber.

In a further non-limiting embodiment of any of the foregoing traction battery packs, the air gap includes a vacuum pocket inside the second chamber that is completely devoid of air.

In a further non-limiting embodiment of any of the foregoing traction battery packs, the floor includes an interior wall that faces toward an interior area of the enclosure assembly, an exterior wall that faces toward the exterior environment, and an internal wall enclosed inside of the floor at a location between the interior wall and the exterior wall.

A traction battery pack according to another exemplary aspect of the present disclosure includes, among other things, a cell-to-pack battery system including a cell matrix, and an enclosure assembly including a multi-layered structure that is arranged to interface with the cell matrix. The multi-layered structure includes an interior wall that faces toward an interior area of the enclosure assembly, an exterior wall that faces toward an exterior environment, and an internal wall enclosed inside of the multi-layered structure at a location between the interior wall and the exterior wall. An internal cooling circuit is arranged between the interior wall and the internal wall, and an air gap is arranged between the internal wall and the exterior wall.

In a further non-limiting embodiment of the foregoing traction battery pack, a plurality of walls extend between the interior wall and the internal wall for establishing a plurality of fluid channels of the internal cooling circuit.

In a further non-limiting embodiment of either of the foregoing traction battery packs, at least one standoff extends between the internal wall and the exterior wall.

In a further non-limiting embodiment of any of the foregoing traction battery packs, the air gap includes a static pocket of air or a vacuum pocket that is devoid of air.

In a further non-limiting embodiment of any of the foregoing traction battery packs, the multi-layered structure establishes a floor of an enclosure tray of the enclosure assembly.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIG. 4 is a cross-sectional view through section 4-4 of FIG. 3.

FIG. 5 illustrates an internal cooling circuit of a multi-layered structure of a traction battery pack enclosure assembly.

### DETAILED DESCRIPTION

This disclosure details traction battery packs that include cell-to-pack battery systems. A cell matrix of the cell-to-pack battery system may be positioned within an enclosure assembly of the traction battery pack. The enclosure assembly may include one or more multi-layered structures. Each multi-layered structure may include a first chamber and a second chamber. The first chamber provides an internal cooling circuit for thermally managing the cell matrix, and the second chamber provides an air gap for insulating the cell matrix from an exterior environment. These and other features are discussed in greater detail in the following paragraphs of this detailed description.

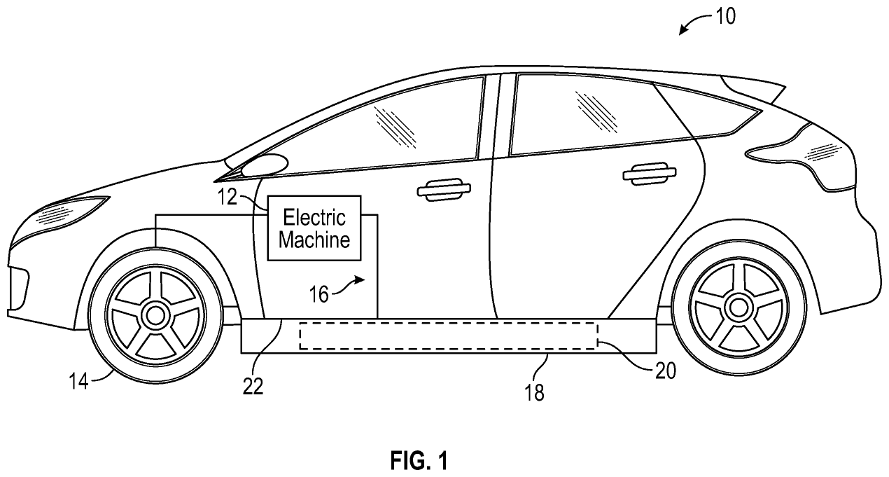

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

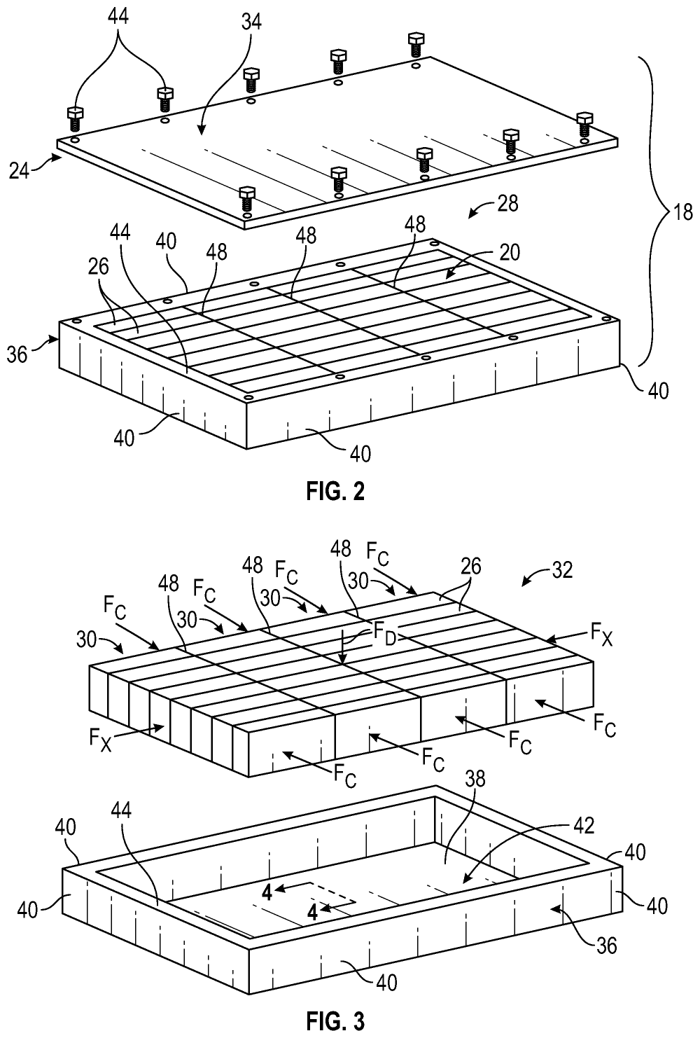

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

In an embodiment, each cell stack 30 includes eight individual battery cells 26, and the cell matrix 32 includes four cell stacks 30 for a total of thirty-two battery cells 26. Providing an even quantity of battery cells 26 and an even quantity of cell stacks 30 can help to support an efficient electrical bussing arrangement. Although a specific number of battery cells 26 and cells stacks 30 are illustrated in the various figures of this disclosure, the cell-to-pack battery system 20 of the traction battery pack 18 could include any number of battery cells 26 and any number of cell stacks 30. In other words, this disclosure is not limited to the exemplary configuration shown in FIGS. 2 and 3.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

The floor 38 may sometimes be referred to as a bottom cover of the enclosure tray 36. During some battery operating conditions, thermal energy may be lost to the exterior environment surrounding the traction battery pack 18 through the floor 38. As further detailed below, the floor 38 may thus be designed to include features (e.g., an air gap, etc.) for minimizing heating/cooling losses to the exterior environment.

During assembly of the traction battery pack 18, the enclosure cover 34 may be secured to the enclosure tray 36 at an interface 44 that substantially circumscribes the interior area 28. In some implementations, mechanical fasteners 46 may be used to secure the enclosure cover 34 to the enclosure tray 36, although other fastening methodologies (adhesion, etc.) could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply forces to the cell matrix 32 when the cell matrix 32 is positioned within the cell-compressing opening 42.

In an embodiment, in order to insert the cell matrix 32 into the cell-compressing opening 42, the cell matrix 32 may first be compressed, and then, while compressed, moved into place in the cell-compressing opening 42. A compressive force F_{C} may be applied to opposed ends of one of the cell stacks 30. The compressive force F_{C} essentially squeezes the battery cells 26 within the cell stack 30, thereby compressing the cell stack 30 and the individual battery cells 26 to a reduced thickness. While the compressive force Fc is applied to the cell stack 30, the cell stack 30 may be inserted into a respective cell-compressing opening 42 by a downward force F_{D}. The downward force F_{D} may be applied directly to one or more of the battery cells 26.

While the term “downward” is used herein to describe the downward force F_{D}, it should be understood that the term “downward” is used herein to refer to all forces tending to press a cell stack 30 into a cell-compressing opening 42. In particular, the term “downward” refers to all forces substantially perpendicular to the compressive forces F_{C}, whether or not the force is truly in a “downward” direction. For example, this disclosure extends to cell stacks that are compressed and inserted into a cell-compressing opening in a sideways direction.

The cell stacks 30 could be individually compressed and inserted into the cell-compressing opening 42. In another embodiment, the entire cell matrix 32 is compressed and inserted into the cell-compressing opening 42. As schematically shown in FIG. 3, in such an embodiment, additional compressive forces F_{X} can compress the cell stacks 30 together for insertion of the cell matrix 32 into the cell-compressing opening 42. The compressive forces F_{X} are generally perpendicular to the compressive forces F_{C}. The compressive forces F_{X} may be applied together with the compressive forces F_{C}. The force FD may then be applied to move the entire cell matrix 32 into the cell-compressing opening 42.

In an embodiment, an entire perimeter of the cell-compressing opening 42 is defined by the side walls 40 of the enclosure tray 36. The side walls 40 can apply a compressive force to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include enclosures holding arrays of battery cells enclosed by array support structures that are spaced apart from walls of a battery enclosure, and where the battery enclosure does not apply compressive forces to any of the battery cells. The cell-to-pack type battery pack described herein also eliminates the rigid cross members that are commonly secured to the enclosure tray of conventional traction battery backs for providing mounting points for securing the battery arrays and the enclosure cover.

The cell-to-pack battery system 20 may further include one or more cell row separators 48. In an embodiment, one cell row separator 48 is positioned between each adjacent pair of cell stacks 30 of the cell matrix 32. In other embodiments, two cell row separators 48 are provided with each cell stack 30. However, the total number of cell row separators 48 provided within the cell-to-pack battery system 20 is not intended to limit this disclosure.

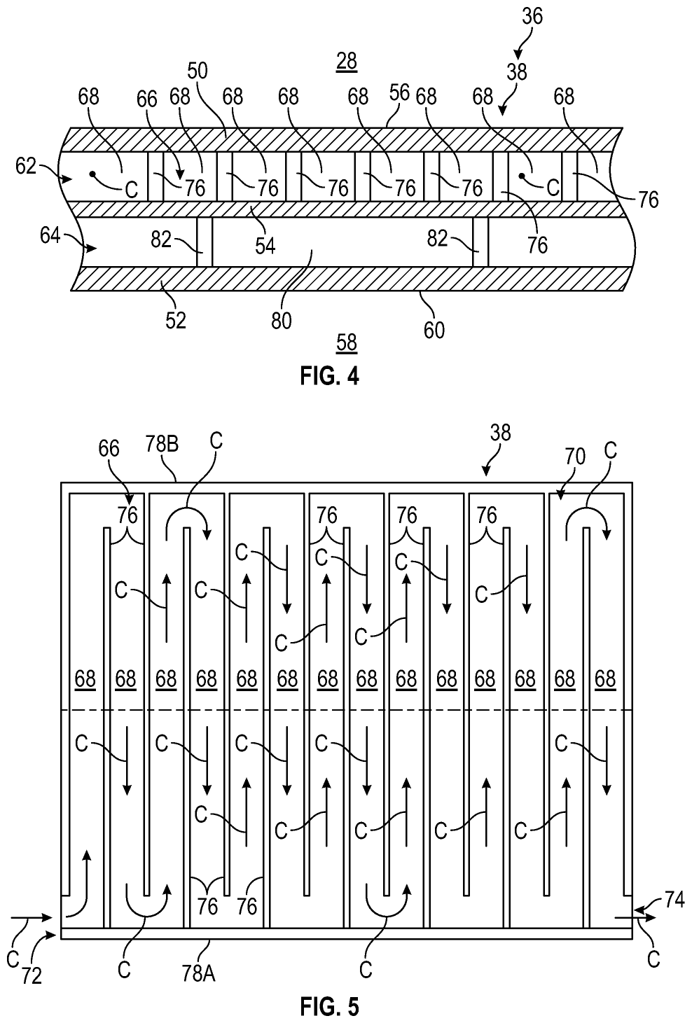

Referring now to FIG. 4, the floor 38 of the enclosure tray 36 may be configured as a multi-layered structure that includes an interior wall 50, an exterior wall 52, and an internal wall 54. The interior wall 50 faces toward the interior area 28 of the enclosure assembly 24 and establishes an interior facing floor surface 56 for supporting the cell matrix 32. The floor 38 may thus interface with the cell matrix 32 at the interior facing floor surface 56. The exterior wall 52 faces toward an exterior environment 58 located outside of the traction battery pack 18. The exterior wall 52 includes an outer surface 60 that is exposed to the exterior environment 58. The internal wall 54 may be enclosed inside of the floor 38 at a location between the interior wall 50 and the exterior wall 52. Each of the interior wall 50, the exterior wall 52, and the internal wall 54 may be a stamped metallic sheet that is either brazed or welded to the other sheets to establish an enclosed, unitary, multi-layered structure of the floor 38.

The internal wall 54 may divide an interior of the floor 38 into a first or upper chamber 62 and a second or lower chamber 64. The upper chamber 62 may extend between the interior wall 50 and the internal wall 54 and is thus located closer to the interior area 28 as compared to the lower chamber 64. The lower chamber 64 may extend between the internal wall 54 and the exterior wall 52 and is thus located closer to the exterior environment 58 as compared to the upper chamber 62.

The upper chamber 62 of the floor 38 may be configured for thermally managing the battery cells 26 of the cell matrix 32. For example, heat may be generated and released by the battery cells 26 during charging operations, discharging operations, extreme ambient conditions, etc. It is often desirable to actively remove the heat from the traction battery pack 18 to enhance the capacity and life of the battery cells 26. The upper chamber 62 may be configured to conduct the heat out of the battery cells 26. In other words, the upper chamber 62 may function as a heat sync to remove heat from the heat sources (i.e., the battery cells 26). The upper chamber 62 can alternatively be employed to heat the battery cells 26, such as during extremely cold ambient conditions.

In an embodiment, an internal cooling circuit 66 may be provided within the upper chamber 62 for performing the heat transfer functions described in the preceding paragraph. A coolant C may be selectively circulated through the internal cooling circuit 66 to thermally condition the battery cells 26 of the cell matrix 32. In an embodiment, the coolant C is a conventional type of coolant mixture such as water mixed with ethylene glycol. However, other coolants, including gases, are also contemplated within the scope of this disclosure.

The internal cooling circuit 66 may include a plurality of fluid channels 68 that extend inside the upper chamber 62 of the floor 38. The fluid channels 68 may connect to one another for communicating the coolant C through upper chamber 62. The size and shape of each fluid channel 68 and the total number of fluid channels 68 are not intended to limit this disclosure and can be specifically tuned to the cooling requirements of the traction battery pack 18.

In an embodiment, the fluid channels 68 establish a serpentine passage 70 inside the floor 38 (see FIG. 5). The serpentine passage 70 extends between an inlet 72 and an outlet 74 of the internal cooling circuit 66.

Walls 76 extend inside the upper chamber 62 to separate adjacent fluid channels 68 of the internal cooling circuit 66 from one another. The walls 76 may connect between the interior wall 50 and the internal wall 54. In an embodiment, each wall 76 extends from one an end wall 78A toward an opposite end wall 78B but terminates prior to reaching the opposing end wall 78A, 78B. For example, the walls 76 may terminate by a distance inwardly from the opposing end wall 78A, 78B (see FIG. 5). In this way, the flow of the coolant C is not blocked by the walls 76 and can turn from one fluid channel 68 to another as it travels along the serpentine passage 70.

In use, the coolant C may be communicated into the inlet 72 of the serpentine passage 70 and may then be communicated through the fluid channels 68 that define the serpentine passage 70 before exiting through the outlet 74. The coolant C picks up the heat conducted through the interior facing floor surface 56 of the interior wall 50 from the battery cells 26 as it meanders along its path. Although not shown, the coolant C exiting the outlet 74 may be delivered to a radiator or some other heat exchanging device, be cooled, and then returned to the inlet 72 in a closed loop.

In an embodiment, the internal wall 54 establishes a floor of the internal cooling circuit 66. The internal wall 54 therefore aids in guiding the coolant C as it circulates through the internal cooling circuit 66.

The lower chamber 64 of the floor 38 may be configured for insulating the battery cells 26 of the cell matrix 32 from the exterior environment 58. An air gap 80 may be provided within the lower chamber 64 for providing the insulating features. The air gap 80 may extend between the internal wall 54 and the exterior wall 52. The air gap 80 may be positioned at any location inside the floor 38 that is between the internal cooling circuit 66 and the portion (e.g., the outer surface 60) of the exterior wall 52 that is exposed to the exterior environment 58.

By providing the insulating features, the air gap 80 is adapted to limit the thermal transfer of energy from the exterior environment 58 into the internal cooling circuit 66 of the upper chamber 62. For example, the air gap 80, which may be a static pocket of air or a vacuum pocket that has been evacuated of air, acts as an insulator so that less heat (or less cooling effect) from the exterior environment 58 is introduced into the internal cooling circuit 66. In other words, the air gap 80 reduces the thermal path between the lower chamber 64 and the upper chamber 62, thereby improving thermal efficiencies.

One or more standoffs 82 may extend inside the floor 38. In an embodiment, the standoffs 82 may extend across the air gap 80 and connect between the internal wall 54 and the exterior wall 52. The standoffs 82 may structurally reinforce the lower chamber 64 of the floor 38. Each standoff 82 may include a foam and/or hex structure, for example.

In the embodiments described above, the floor 38 of the enclosure tray 36 provides the multi-layered enclosure structure for thermally managing and insulating the battery cells 26 of the cell matrix 32. However, other configurations are contemplated within the scope of this disclosure. For example, one or more of the side walls 40 of the enclosure tray 36 could alternatively or additionally include a similar multi-layered structure. In still other implementations, a similar multi-layered structure could alternatively or additionally be integrated into the enclosure cover 34.

The exemplary traction battery packs of this disclosure include multi-layered enclosure structures for providing both thermal management and insulating features to a cell matrix of a cell-to-pack battery system. The traction battery packs described herein are therefore better equipped to reduce heating and cooling loses to the exterior environment.

Although the different non-limiting embodiments are illustrated as having specific components or steps, the embodiments of this disclosure are not limited to those particular combinations. Some of the components or features from any of the non-limiting embodiments may be used in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure tray; and
a cell-to-pack battery system housed within the enclosure assembly and including a cell matrix,
wherein a floor of the enclosure tray includes a first chamber that provides an internal cooling circuit for thermally managing the cell matrix and a second chamber that provides an air gap for insulating the cell matrix from an exterior environment.

2. The traction battery pack as recited in claim 1, wherein the cell matrix includes a plurality of battery cells arranged to interface with an interior facing floor surface of an interior wall of the floor.

3. The traction battery pack as recited in claim 1, wherein the floor is connected to a plurality of side walls of the enclosure tray.

4. The traction battery pack as recited in claim 3, wherein the plurality of side walls are arranged to provide a cell-compressing opening for compressing the cell matrix.

5. The traction battery pack as recited in claim 1, wherein the internal cooling circuit extends between an interior wall and an internal wall of the floor.

6. The traction battery pack as recited in claim 5, wherein the internal cooling circuit includes a plurality of fluid channels that are at least partially separated from one another by a plurality of walls.

7. The traction battery pack as recited in claim 6, wherein the internal cooling circuit establishes a serpentine passage inside the first chamber.

8. The traction battery pack as recited in claim 1, wherein the first chamber is closer to the cell matrix than the second chamber.

9. The traction battery pack as recited in claim 1, wherein the second chamber extends between an internal wall and an exterior wall of the floor.

10. The traction battery pack as recited in claim 9, wherein the internal wall establishes a floor of the internal cooling circuit.

11. The traction battery pack as recited in claim 9, wherein the exterior wall includes an exterior surface that is exposed to the exterior environment.

12. The traction battery pack as recited in claim 9, comprising at least one standoff extending between the internal wall and the exterior wall of the floor.

13. The traction battery pack as recited in claim 1, wherein the air gap includes a static pocket of air inside the second chamber.

14. The traction battery pack as recited in claim 1, wherein the air gap includes a vacuum pocket inside the second chamber and that is completely devoid of air.

15. The traction battery pack as recited in claim 1, wherein the floor includes an interior wall that faces toward an interior area of the enclosure assembly, an exterior wall that faces toward the exterior environment, and an internal wall enclosed inside of the floor at a location between the interior wall and the exterior wall.

16. A traction battery pack, comprising:
a cell-to-pack battery system including a cell matrix;
an enclosure assembly including a multi-layered structure that is arranged to interface with the cell matrix;
the multi-layered structure including an interior wall that faces toward an interior area of the enclosure assembly, an exterior wall that faces toward an exterior environment, and an internal wall enclosed inside of the multi-layered structure at a location between the interior wall and the exterior wall;
an internal cooling circuit arranged between the interior wall and the internal wall; and
an air gap arranged between the internal wall and the exterior wall.

17. The traction battery pack as recited in claim 16, comprising a plurality of walls that extend between the interior wall and the internal wall for establishing a plurality of fluid channels of the internal cooling circuit.

18. The traction battery pack as recited in claim 16, comprising at least one standoff that extends between the internal wall and the exterior wall.

19. The traction battery pack as recited in claim 16, wherein the air gap includes a static pocket of air or a vacuum pocket that is devoid of air.

20. The traction battery pack as recited in claim 16, wherein the multi-layered structure establishes a floor of an enclosure tray of the enclosure assembly.
